(19) United States
(12) Patent Application Publication
(10) Pub. No.: US 2025/0282185 A1
(43) Pub. Date: Sep. 11, 2025

(54) PNEUMATIC TIRE

(71) Applicant: Sumitomo Rubber Industries, Ltd., Kobe-shi (JP)

(72) Inventor: Tatsuya KOIDE, Kobe-shi (JP)

(73) Assignee: Sumitomo Rubber Industries, Ltd., Kobe-shi (JP)

(21) Appl. No.: 19/049,813

(22) Filed: Feb. 10, 2025

(30) Foreign Application Priority Data
Mar. 8, 2024 (JP) 2024-036116

(51) Int. Cl. B60C 15/06; B60C 9/20

(52) U.S. Cl. CPC B60C 15/0632; B60C 9/20; B60C 15/0603; B60C 15/0653; B60C 2009/2016; B60C 2009/2019; B60C 2015/0667

(57) ABSTRACT

A pneumatic tire comprises a bead portion, a carcass, a bead reinforcing layer and a bead apex rubber. The carcass comprises a first carcass ply of carcass cords arranged at an angle of 60 to 90 degrees with respect to the tire circumferential direction. The bead reinforcing layer comprises a first reinforcing ply of bead reinforcing cords arranged at an angle of 60 to 90 degrees with respect to the tire circumferential direction. The first carcass ply is composed of a main portion and a turnup portion continued from the main portion. The first reinforcing ply comprises a first portion and a second portion continued from the first portion. The radially outer end of the second portion is located on the axially outer side of the bead apex rubber and on the radially inner side of the radially outer end of the bead apex rubber.

### TECHNICAL FIELD

The present disclosure relates to a pneumatic tire.

### BACKGROUND ART

Various pneumatic tires suitable for high-speed running have been proposed. For example, Patent Document 1 below discloses a pneumatic tire in which, in order to improve durability while achieving a weight reduction, the bead portion is provided with a bead reinforcing cord layer comprising a first portion disposed on the axially outside of a carcass ply main portion and a second portion disposed on the axially inside of a carcass ply turnup portion.

Patent Document 1: Japanese Patent Application Publication No. 2021-172104

### SUMMARY OF THE INVENTION

### Problems to be Solved by the Invention

In the bead reinforcing cord layer disclosed in Patent Document 1, as the first portion and the second portion are close to each other, there may be cases where the cord tensions of the respective parts act on them mutually, and as a result, the desired reinforcing effect on the vertical stiffness, lateral stiffness and forward/backward stiffness of the bead portion can not be achieved.

The present disclosure was therefore, made in view of the above-described circumstances, and

a primary objective of the present disclosure is to provide a pneumatic tire in which driving force and steering stability can be improved, while achieving lightweight.

### Means for Solving the Problems

According to the present disclosure, a pneumatic tire comprises:
a pair of bead portions each with a bead core embedded therein;
a carcass extending between the bead portions through a tread portion and sidewall portions;
a bead reinforcing layer disposed in each of the bead portions; and
a bead apex rubber extending radially outwardly from the bead core in each of the bead portions,
   wherein
the carcass comprises a first carcass ply of carcass cords arranged at an angle of 60 to 90 degrees with respect to the tire circumferential direction,
the bead reinforcing layer comprises a first reinforcing ply of bead reinforcing cords arranged at an angle of 60 to 90 degrees with respect to the tire circumferential direction,
the first carcass ply comprises a main portion and a pair of turnup portions continued from the main portion and each folded back around the bead core from the inside to the outside in the tire axial direction,
in each of the bead portions, the first reinforcing ply comprises a first portion disposed along the main portion of the first carcass ply, and a second portion continued from the first portion and folded back around the bead core from the inside to the outside in the tire axial direction so as to be disposed along the turnup portion of the first carcass ply, and
a radially outer end of the second portion is located on the axially outside of the bead apex rubber and on the radially inside of a radially outer end of the bead apex rubber.

### Effects of the Invention

By having the above-described structure, the pneumatic tire according to the present disclosure can be improved in driving force and steering stability while achieving a weight reduction.

### BRIEF DESCRIPTION OF THE DRAWINGS

FIG. 1 is a cross-sectional view of a pneumatic tire as an embodiment of the present disclosure.

FIG. 2 is an enlarged view showing the sidewall portion and bead portion thereof.

### DETAILED DESCRIPTION OF THE INVENTION

An embodiment of the present disclosure will now be described in detail in conjunction with the drawings.

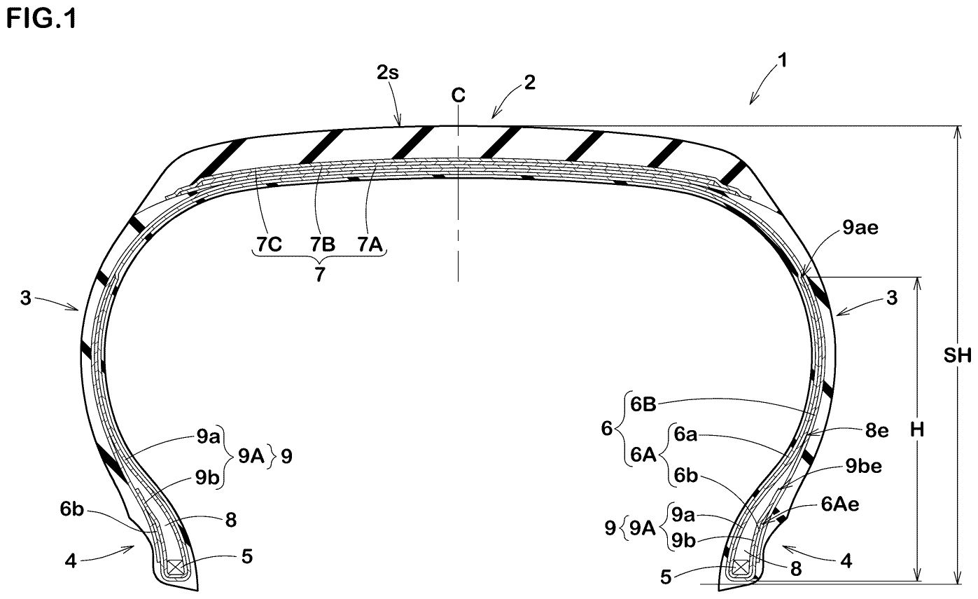

FIG. 1 is a tire meridian cross-sectional view showing a pneumatic tire 1 according to the present embodiment under its standard state.

Here, the “standard state” of a pneumatic tire means a state of the tire which is mounted on a standard rim and inflated to a standard pressure, but loaded with no tire load.

In this application including specification and claims, dimensions and positions of each part or portion of the tire refer to those under the standard state unless otherwise noted,

In the case that the pneumatic tire 1 is a type of pneumatic tire for which various standards have been established, the “standard wheel rim” is a wheel rim specified for the tire in a standard system including standards on which the tire is based, for example, the “Standard rim” in JATMA, “Design Rim” in TRA, “Measuring Rim” in ETRTO.

In the case that the pneumatic tire 1 is a tire for which various standards are not yet established, the “standard wheel rim” means a wheel rim having a smallest rim diameter and a smallest rim width among the wheel rims that can be assembled with the tire without causing air leakage.

In the case that the pneumatic tire 1 is a type of pneumatic tire for which various standards have been established, the “standard tire pressure” is the air pressure specified for the tire in a standard system including standards on which the tire is based, for example, the “maximum air pressure” in JATMA, “INFLATION PRESSURE” in ETRTO, and the maximum air pressure listed in the table “TIRE LOAD LIMITS AT VARIOUS COLD INFLATION PRESSURES” in TRA.

In the case that the pneumatic tire 1 is a tire for which various standards are not yet established, the “standard tire pressure” is the air pressure specified for the tire by the tire manufacturer or the like.

The pneumatic tire 1 shown in FIG. 1 has a structure suitable for high-speed running such as circuit running.

However, the present disclosure is not limited to such pneumatic tire, and can be applied to various pneumatic tires such as passenger car tires, heavy duty tires, motorcycle tires and the like.

The pneumatic tire 1 in the present embodiment comprises
a tread portion 2 having a ground contacting surface 2s,
a pair of sidewall portions 3 extending radially inwardly from both sides in the tire axial direction of the tread portion 2, and
a pair of bead portions 4 coming into contact with a wheel rim.

The bead portions 4 are located radially inside the sidewall portions 3, respectively.

In the present embodiment, an annular bead core 5 extending in the tire circumferential direction is embedded in each of the bead portions 4.
For example, the bead core 5 is made of at least one steel wire wound.

It is preferable that the pneumatic tire 1 comprises
a carcass 6 extending between the bead portions 4, and
a belt 7 disposed radially outside the carcass 6 in the tread portion 2.
   In such pneumatic tire 1, deformation of the tread portion 2 when a load is applied can be suppressed by the belt 7, while reducing the tire weight.

In the present embodiment, the carcass 6 comprises a first carcass ply 6A of carcass cords (not shown) which are arranged at an angle of 60 to 90 degrees with respect to the tire circumferential direction.

It is preferable that the first carcass ply 6A comprises
a main portion 6a extending between the bead portions 4, and
a pair of turnup portions 6b continued from the main portion 6a and folded back around the bead cores 5 in the bead portions from the inside to the outside in the tire axial direction.
   Such first carcass ply 6A serves to achieve both suppression of deformation when a high load is applied and weight reduction.

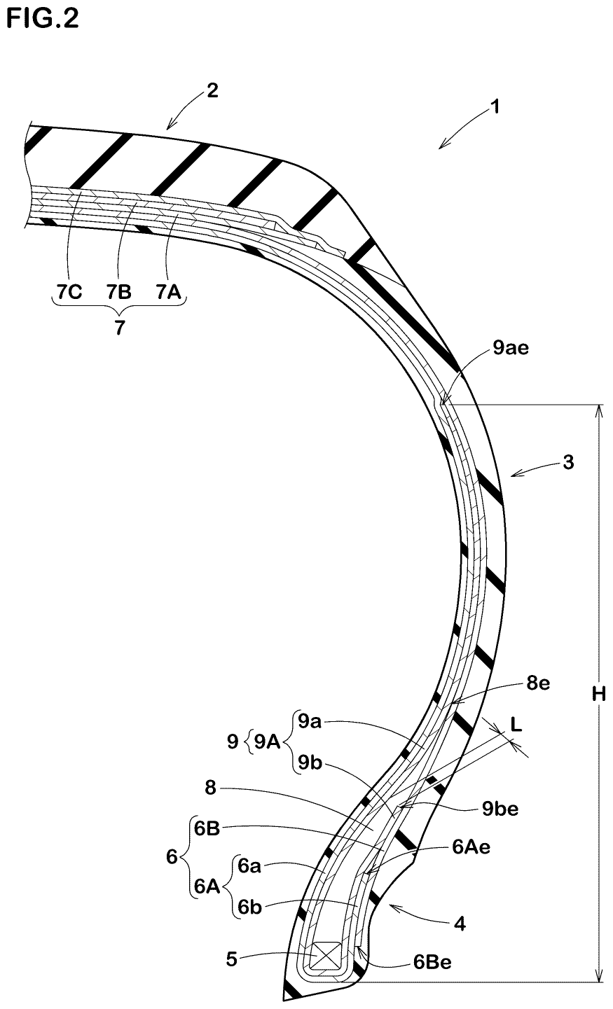

FIG. 2 shows the sidewall portion 3 and bead portion 4 of the pneumatic tire 1 in the present embodiment.

As shown in FIGS. 1 and 2, each of the bead portions 4 is provided with a bead apex rubber 8 and a bead reinforcing layer 9 in order that the bead reinforcing layer 9 can improve the stiffness of the bead portion 4 while achieving a tire weight reduction.

The bead apex rubber 8 extends radially outwardly from the bead core 5.

The bead reinforcing layer 9 in this example comprises a first reinforcing ply 9A of bead reinforcing cords (not shown) which are arranged at an angle of 60 to 90 degrees with respect to the tire circumferential direction.

Such bead reinforcing layer 9 can reduce the forward/backward stiffness while maintaining good vertical stiffness and lateral stiffness, and can improve the driving force of the pneumatic tire 1.

It is preferable that, in each of the bead portions 4, the first reinforcing ply 9A comprises a first portion 9a and a second portion 9b, the second portion 9b extending continuously from the first portion 9a.

The first portion 9a is, for example, a portion disposed along the main portion 6a of the first carcass ply 6A.
Preferably, the first portion 9a is disposed, abutting on the axially outer side of the main portion 6a.

The second portion 9b includes, for example, a portion which is folded back around the bead core 5 from the inner side to the outer side in the tire axial direction, and arranged along the turnup portion 6b of the first carcass ply 6A.

Preferably, the second portion 9b is disposed, abutting on the axially inner side of the turnup portion 6b.

In the present embodiment, the radially outer end 9be of the second portion 9b is located radially inside the radially outer end 8e of the bead apex rubber 8 on the axially outer side of the bead apex rubber 8.

Such bead reinforcing layer 9 can generate tension in the bead reinforcing cords when the bead apex rubber 8 is deformed, and can improve lateral stiffness of the bead portion during cornering.
Therefore, the pneumatic tire 1 of the present embodiment can be improved in driving force and steering stability while achieving a tire weight reduction.

Preferably, the radially outer end 9be of the second portion 9b is located radially inside the radially outer end 9ae of the first portion 9a.

Such bead reinforcing layer 9 can suppress damage starting from the radially outer end 9be of the axially outwardly located second portion 9b, and thereby can improve the durability of the pneumatic tire 1.

Preferably, the minimum distance L between the radially outer end 9be of the second portion 9b and the axially outer surface of the first portion 9a is not less than 0.5 mm.

By setting the minimum distance L to 0.5 mm or more, it becomes possible to reliably generate tension in the bead reinforcement cords when the bead apex rubber 8 is deformed.

As shown in FIG. 1, the height H in the tire radial direction (of the first portion in this example) of the first reinforcing ply 9A is preferably not less than 10% of the cross-sectional height SH of the tire.

By setting the height H to 10% or more of the cross-sectional height SH, the contact area between the first reinforcing ply 9A and the bead apex rubber 8 can be secured, and it becomes possible to reliably generate the tension of the bead reinforcing cords when the bead apex rubber 8 is deformed.

From this viewpoint, the height H of the first reinforcing ply 9A is more preferably set to be 20% or more of the cross-sectional height SH.

On the other hand, from the viewpoint of weight reduction, it is preferable that the height H of the first reinforcing ply 9A is 80% or less of the cross-sectional height SH.

Accordingly, the height H of the first reinforcing ply 9A is preferably 10% to 80%, more preferably 20% to 80% of the cross-sectional height SH.

In the present embodiment, the radially outer end 9ae of the first portion 9a of the first reinforcing ply 9A is located radially outside the maximum tire section width position (about one half of SH).

Incidentally, the bead reinforcing layer 9 may further include another reinforcing ply (not shown) in addition to the first reinforcing ply 9A, for example.

It is preferable that the complex elastic modulus of the bead apex rubber 8 at 70 degrees C. is 55 to 70 MPa.

By setting the complex elastic modulus of the bead apex rubber 8 to 55 MPa or more, the stiffness of the bead portion 4 can be improved.
By setting the complex elastic modulus of the bead apex rubber 8 to 70 MPa or less, deformation which is sufficient to generate tension in the bead reinforcing layer 9 can be ensured.

In this specification, the complex elastic modulus is measured using a dynamic viscoelasticity measuring device (EPLEXER series developed by GABO) under the following conditions in accordance with the provisions of JIS-K6394 “Rubber, vulcanized or thermoplastic—Determination of dynamic properties—General guidance”.
Initial strain: 5%
Dynamic strain amplitude: +/−1%
Frequency: 10 Hz
Deformation mode: Stretch
Measurement temperature: 70 deg. C

It is preferable that the radially outer end 6Ae of the turnup portion 6b of the first carcass ply 6A is located radially inside the radially outer end 9be of the second portion 9b of the first reinforcing ply 9A.

Such first carcass ply 6A can suppress possible damage starting from the radially outer end 6Ae of the turnup portion 6b, and can improve the durability of the pneumatic tire 1.

It is preferable that the carcass 6 comprises a second carcass ply 6B disposed radially outside the first carcass ply 6A in the tread portion 2.

The second carcass ply 6B in this example extends between the bead portions 4 through the tread portion 2 and sidewall portions 3.
From the sidewall portion to the bead portion, the second carcass ply 6B extends radially inwardly on the axially outer side of the bead apex rubber 8 and the axially outer side of the bead reinforcing layer 9, and has a radially inner end 6Be terminated in the bead portion 4 without being folded back around the bead core 5.
Such second carcass ply 6B can achieve both suppression of deformation when a high load is applied and weight reduction.

It is preferable that the radially inner end 6Be of the second carcass ply 6B is located radially inside the radially outer end 6Ae of the turnup portion 6b of the first carcass ply 6A.

In this example, the radially inner end 6Be of the second carcass ply 6B is located on the axially outer side of the bead core 5.
Such second carcass ply 6B can suppress possible damage starting from the radially outer end 6Ae of the turnup portion 6b of the first carcass ply 6A, and can improve the durability of the pneumatic tire 1.

The second carcass ply 6B in this example is made of a plurality of carcass cords (not shown) arranged at an angle of 60 to 90 degrees with respect to the tire circumferential direction like the first carcass ply 6A.

When the angle of the carcass cords of the first carcass ply 6A and the angle of the carcass cords of the second carcass ply 6B are less than 90 degrees, it is preferable that, with respect to the tire circumferential direction, the inclining direction of the carcass cords of the first carcass ply 6A is opposite to the inclining direction of the carcass cords of the second carcass ply 6B.
Such second carcass ply 6B can cooperate with the first carcass ply 6A to suppress deformation when a high load is applied.

In the present embodiment, the belt 7 is composed of a first belt ply 7A, a second belt ply 7B disposed on the radially outer side of the first belt ply 7A, and a third belt ply 7C disposed on the radially outer side of the second belt ply 7B.

Such belt 7 can increase the stiffness of the tread portion 2, suppress deformation when loaded, and improve the steering stability of the pneumatic tire 1.

In the present embodiment, the first belt ply 7A is disposed on the radially outside of the second carcass ply 6B.

Preferably, the first belt ply 7A is made of parallel belt cords (not shown) arranged at an angle of from 24 to 45 degrees with respect to the tire circumferential direction.
Such first belt ply 7A can maintain appropriate lateral stiffness in cooperation with bead reinforcing layer 9, and help to improve the steering stability of the pneumatic tire 1.

The second belt ply 7B in this example is made of parallel belt cords (not shown) arranged at an angle of 24 to 45 degrees with respect to the tire circumferential direction like the first belt ply 7A.

With respect to the tire circumferential direction, the inclining direction of the belt cords of the first belt ply 7A is preferably opposite to the inclining direction of the belt cords of the second carcass ply 6B.
Such second carcass ply 6B can work together with the first belt ply 7A to increase the stiffness of the tread portion 2, suppress deformation when loaded, and improve the steering stability of the pneumatic tire 1.

For example, the third belt ply 7C may be made of a plurality of parallel belt cords (not shown) arranged at an inclination angle with respect to the tire circumferential direction, similarly to the first belt ply 7A and the second carcass ply 6B, or

a belt cord arranged substantially parallel to the tire circumferential direction, for example, wound spirally in the tire circumferential direction.
Such third belt ply 7C can work together with the first belt ply 7A and the second carcass ply 6B to increase the stiffness of the tread portion 2, suppress deformation when loaded, and improve the steering stability of the pneumatic tire 1.

While detailed description has been made of an especially preferable embodiment of the present disclosure, the present disclosure can be embodied in various forms without being limited to the illustrated embodiment.

### STATEMENT OF THE PRESENT DISCLOSURE

The present disclosure is as follows:

### Present Disclosure 1

A pneumatic tire comprising:
a pair of bead portions each with a bead core embedded therein;
a carcass extending between the bead portions through a tread portion and sidewall portions;
a bead reinforcing layer disposed in each of the bead portions; and
a bead apex rubber extending radially outwardly from the bead core in each of the bead portions,
   wherein
the carcass comprises a first carcass ply of carcass cords arranged at an angle of 60 to 90 degrees with respect to the tire circumferential direction,
the bead reinforcing layer comprises a first reinforcing ply of bead reinforcing cords arranged at an angle of 60 to 90 degrees with respect to the tire circumferential direction,
the first carcass ply comprises a main portion and a pair of turnup portions continued from the main portion and each folded back around the bead core from the inside to the outside in the tire axial direction,
in each of the bead portions, the first reinforcing ply comprises a first portion disposed along the main portion of the first carcass ply, and a second portion continued from the first portion and folded back around the bead core from the inside to the outside in the tire axial direction so as to be disposed along the turnup portion of the first carcass ply, and
a radially outer end of the second portion is located on the axially outside of the bead apex rubber and on the radially inside of a radially outer end of the bead apex rubber.

### Present Disclosure 2

The pneumatic tire according to Present Disclosure 2, wherein
a radially outer end of the second portion is located radially inside a radially outer end of the first portion.

### Present Disclosure 3

The pneumatic tire according to Present Disclosure 2, wherein
a minimum distance between the radially outer end of the second portion and the first portion is 0.5 mm or more.

### Present Disclosure 4

The pneumatic tire according to Present Disclosure 1, 2 or 3, wherein
a height in the tire radial direction of the first reinforcing ply is 10% or more of a cross-sectional height of the tire.

### Present Disclosure 5

The pneumatic tire according to Present Disclosure 4, wherein
the height in the tire radial direction of the first reinforcing ply is 20% to 80% of the cross-sectional height of the tire.

### Present Disclosure 6

The pneumatic tire according to any one of Present Disclosures 1 to 5, wherein
a complex elastic modulus of the bead apex rubber at 70 degrees C. is in a range from 55 to 70 MPa.

### Present Disclosure 7

The pneumatic tire according to any one of Present Disclosures 1 to 6, wherein
the tread portion is provided with a belt layer disposed on the radially outside of the carcass, and
the belt layer comprises a first belt ply of belt cords arranged at an angle of 24 to 45 degrees with respect to the tire circumferential direction.

### DESCRIPTION OF THE REFERENCE SIGNS

1 pneumatic tire
4 bead portion
6 carcass
6A first carcass ply
6a main portion
6b turnup portion
8 bead apex rubber
8e radially outer end of bead apex rubber
9 bead reinforcing layer
9A first reinforcing ply
9a first portion
9b second portion
9be radially outer end of second portion

1. A pneumatic tire comprising:
a pair of bead portions each with a bead core embedded therein;
a carcass extending between the bead portions through a tread portion and sidewall portions;
a bead reinforcing layer disposed in each of the bead portions; and
a bead apex rubber extending radially outwardly from the bead core in each of the bead portions,
wherein
the carcass comprises a first carcass ply of carcass cords arranged at an angle of 60 to 90 degrees with respect to the tire circumferential direction,
the bead reinforcing layer comprises a first reinforcing ply of bead reinforcing cords arranged at an angle of 60 to 90 degrees with respect to the tire circumferential direction,
the first carcass ply comprises a main portion, and a pair of turnup portions continued from the main portion and each folded back around the bead core from the inside to the outside in the tire axial direction,
in each of the bead portions, the first reinforcing ply comprises
a first portion disposed on the axially outside of the main portion of the first carcass ply, and
a second portion continued from the first portion and folded back around the bead core from the inside to the outside in the tire axial direction so as to be disposed on the axially inside of the turnup portion of the first carcass ply, and
a radially outer end of the second portion is located on the axially outside of the bead apex rubber and on the radially inside of a radially outer end of the bead apex rubber.

2. The pneumatic tire according to claim 1, wherein
a radially outer end of the second portion is located radially inside a radially outer end of the first portion.

3. The pneumatic tire according to claim 2, wherein
a minimum distance between the radially outer end of the second portion and the first portion is 0.5 mm or more.

4. The pneumatic tire according to claim 1, wherein
a height in the tire radial direction of the first reinforcing ply is 10% or more of a cross-sectional height of the tire.

5. The pneumatic tire according to claim 1, wherein
a height in the tire radial direction of the first reinforcing ply is 20% to 80% of a cross-sectional height of the tire.

6. The pneumatic tire according to claim 2, wherein
a height in the tire radial direction of the first reinforcing ply is 20% to 80% of a cross-sectional height of the tire.

7. The pneumatic tire according to claim 3, wherein
a height in the tire radial direction of the first reinforcing ply is 20% to 80% of a cross-sectional height of the tire.

8. The pneumatic tire according to claim 2, wherein
a complex elastic modulus of the bead apex rubber at 70 degrees C. is in a range from 55 to 70 MPa.

9. The pneumatic tire according to claim 3, wherein
a complex elastic modulus of the bead apex rubber at 70 degrees C. is in a range from 55 to 70 MPa.

10. The pneumatic tire according to claim 7, wherein
a complex elastic modulus of the bead apex rubber at 70 degrees C. is in a range from 55 to 70 MPa.

11. The pneumatic tire according to claim 1, wherein
the tread portion is provided with a belt layer disposed on the radially outside of the carcass, and
the belt layer comprises a first belt ply of belt cords arranged at an angle of 24 to 45 degrees with respect to the tire circumferential direction.

12. The pneumatic tire according to claim 1, wherein
the tread portion is provided with a belt layer disposed on the radially outside of the carcass, and
the belt is composed of a first belt ply, a second belt ply disposed on the radially outer side of the first belt ply, and a third belt ply disposed on the radially outer side of the second belt ply,
the first belt ply is made of parallel belt cords arranged at an angle of from 24 to 45 degrees with respect to the tire circumferential direction,
the second belt ply is made of parallel belt cords arranged at an angle of 24 to 45 degrees with respect to the tire circumferential direction, and
the third belt ply is made of parallel belt cords arranged at an inclination angle with respect to the tire circumferential direction, or alternatively a belt cord arranged substantially parallel to the tire circumferential direction.

13. The pneumatic tire according to claim 1, wherein
the carcass comprises a second carcass ply in addition to the first carcass ply,
the second carcass ply is made of carcass cords arranged at an angle of 60 to 90 degrees with respect to the tire circumferential direction, and extends between the bead portions through the tread portion and the sidewall portions, and
the second carcass ply extends radially inwardly from the tread portion to each of the bead portions, abutting on the first carcass ply, an axially outer side of the first portion of the bead reinforcing layer, an axially outer side of the bead apex rubber, an axially outer side of the second portion the bead reinforcing layer, and an axially outer side of the turnup portion of the first carcass ply in this order, and terminates in the bead portion without being folded back around the bead core to have a radially inner end on the axially outside of the bead core.

14. The pneumatic tire according to claim 3, wherein
the carcass comprises a second carcass ply in addition to the first carcass ply,
the second carcass ply is made of carcass cords arranged at an angle of 60 to 90 degrees with respect to the tire circumferential direction, and extends between the bead portions through the tread portion and the sidewall portions, and
the second carcass ply extends radially inwardly from the tread portion to each of the bead portions, abutting on the first carcass ply, an axially outer side of the first portion of the bead reinforcing layer, an axially outer side of the bead apex rubber, an axially outer side of the second portion the bead reinforcing layer, and an axially outer side of the turnup portion of the first carcass ply in this order, and terminates in the bead portion without being folded back around the bead core to have a radially inner end on the axially outside of the bead core.

15. The pneumatic tire according to claim 7, wherein
the carcass comprises a second carcass ply in addition to the first carcass ply,
the second carcass ply is made of carcass cords arranged at an angle of 60 to 90 degrees with respect to the tire circumferential direction, and extends between the bead portions through the tread portion and the sidewall portions, and
the second carcass ply extends radially inwardly from the tread portion to each of the bead portions, abutting on the first carcass ply, an axially outer side of the first portion of the bead reinforcing layer, an axially outer side of the bead apex rubber, an axially outer side of the second portion the bead reinforcing layer, and an axially outer side of the turnup portion of the first carcass ply in this order, and terminates in the bead portion without being folded back around the bead core to have a radially inner end on the axially outside of the bead core.

16. The pneumatic tire according to claim 10, wherein
the carcass comprises a second carcass ply in addition to the first carcass ply,
the second carcass ply is made of carcass cords arranged at an angle of 60 to 90 degrees with respect to the tire circumferential direction, and extends between the bead portions through the tread portion and the sidewall portions, and
the second carcass ply extends radially inwardly from the tread portion to each of the bead portions, abutting on the first carcass ply, an axially outer side of the first portion of the bead reinforcing layer, an axially outer side of the bead apex rubber, an axially outer side of the second portion the bead reinforcing layer, and an axially outer side of the turnup portion of the first carcass ply in this order, and terminates in the bead portion without being folded back around the bead core to have a radially inner end on the axially outside of the bead core.

17. The pneumatic tire according to claim 13 wherein
the radially inner end of the second carcass ply is located radially inside the radially outer end of the turnup portion of the first carcass ply.

18. The pneumatic tire according to claim 14, wherein
the radially inner end of the second carcass ply is located radially inside the radially outer end of the turnup portion of the first carcass ply.

19. The pneumatic tire according to claim 15, wherein
the radially inner end of the second carcass ply is located radially inside the radially outer end of the turnup portion of the first carcass ply.

20. The pneumatic tire according to claim 16, wherein
the radially inner end of the second carcass ply is located radially inside the radially outer end of the turnup portion of the first carcass ply.
